(19) United States
(12) Patent Application Publication
(10) Pub. No.: US 2007/0187308 A1
(43) Pub. Date: Aug. 16, 2007

(54) Pressure relief valve for fluid filter system

(76) Inventor: Keith R. Weinberger, Randolph, NJ (US)

Correspondence Address: MCANDREWS HELD & MALLOY, LTD, 500 WEST MADISON STREET, SUITE 3400, CHICAGO, IL, 60661, US

(21) Appl. No.: 11/352,682

(22) Filed: Feb. 13, 2006

(51) Int. Cl. B01D 35/14

(52) U.S. Cl. 210/130; 210/420; 210/433.1

(57) ABSTRACT

An oil or other fluid filter is shown, having a filter path, a filter element, a bypass passage, and a pressure relief valve controlling the flow of a fluid through the bypass passage. The pressure relief valve has a seat, a valve seal, and spring legs. The spring legs are generally circumferentially spaced about the valve seal. The spring legs have proximal portions secured to the valve seal and more distal portions bearing against an upstream wall of the bypass passage. This bearing relation biases the valve seal against the lip to normally close the valve unless it is opened by a large pressure drop across the valve. In an optional embodiment, the valve seal and the spring legs can be formed together as a single piece of material, for example spring metal.

### BACKGROUND OF THE INVENTION

The present invention relates to an oil or other fluid filter having a pressure relief valve to bypass the filter element when its resistance to fluid flow becomes too great, as when the filter is plugged with filtrate.

A typical oil filter for an internal combustion engine is a cartridge having a threaded fitting to engage the engine block. The entire cartridge is typically replaced when the filter is spent.

While it is vital to filter the oil regularly to remove debris, it is even more vital to maintain continuous lubrication of the engine, even at the expense of filtering. Thus, an oil filter cartridge commonly is equipped with an internal bypass valve that bypasses the filter element when the inlet pressure of the filter is too much higher than its outlet pressure. This pressure difference arises when the filter becomes too resistant to flow, as when it is clogged with filtrate or during cold start-up, when the oil is too viscous to flow efficiently. When the bypass valve opens the oil is not being filtered, but its continued supply to the engine is assured, avoiding a potentially catastrophic failure of lubrication and allowing the filter to be replaced at a convenient time, such as the next scheduled oil change.

One known type of pressure relief valve is an assembly of a valve seat interposed in a bypass passage, a valve plate having a sealing plug or other element downstream of and seated against the valve seat and a coil spring compressed between the upstream side of the valve seat and a spring abutment on the sealing element, biasing the sealing element upstream against the seat. When the pressure drop across the seat from its upstream side to its downstream side is great enough to overcome the spring bias, the sealing plug shifts downstream away from the valve seat, allowing fluid to bypass the filter element. Such a valve is shown, for example, in U.S. Pat. No. 4,990,247. A disadvantage of this type of pressure relief valve is that the valve plug and spring are separate parts, fabricated of different materials and requiring assembly. This two-part structure is thus relatively expensive to make and assemble, particularly in an inexpensive product.

### SUMMARY OF THE INVENTION

Certain embodiments provide a filter, for example an oil filter, having a filter path, a filter element, a bypass passage, and a pressure relief valve controlling the flow of a fluid through the bypass passage.

The filter path has an inlet and an outlet. The filter element is located in the filter path between the inlet and the outlet.

The bypass passage is defined by walls and extends between the inlet and the outlet of the filter path. The pressure relief valve is located in the bypass passage. The pressure relief valve opens, allowing oil to bypass the filter element, when the pressure in the inlet exceeds the pressure in the outlet by an amount sufficient to open the valve.

The pressure relief valve has a seat, a valve seal, and two or more spring legs.

The seat has an upstream side and a downstream side. Upstream walls of the bypass passage define the upstream side of the seat, and downstream walls of the bypass passage define the downstream side of the seat. The downstream side of the seat defines a lip surrounding the bypass passage.

The valve seal is positioned in the bypass passage and has an upstream-facing sealing surface. The valve seal has a closed position against the lip of the valve seat and an open position spaced downstream of the lip of the valve seat, allowing fluid to flow through the bypass passage. The valve seal is movable downstream from its closed position to its open position.

The spring legs are generally circumferentially spaced about the valve seal. The spring legs have proximal portions secured to the valve seal and more distal portions bearing against an upstream wall of the bypass passage. This bearing relation biases the valve seal against the lip.

In an optional embodiment, the valve seal and the spring legs can be formed together as a single piece of material, for example spring metal.

### BRIEF DESCRIPTION OF SEVERAL VIEWS OF THE DRAWINGS

FIG. 1 is an axial section of a fluid filter, in an embodiment an engine oil filter, showing the bypass valve closed.

FIG. 2 is a detail view similar to FIG. 1, showing the bypass valve in isolation. closed in full lines and open in phantom lines.

FIG. 3 is a top plan view of the valve seal and spring legs in isolation.

FIG. 4 is a view similar to FIG. 1, showing a different embodiment in which the bypass valve is incorporated in a conventional spin-on disposable oil filter of a common design.

The foregoing summary, as well as the following detailed description of certain embodiments, will be better understood when read in conjunction with the appended drawings. For the purpose of illustrating the invention, certain embodiments are shown in the drawings. It should be understood, however, that the present invention is not limited to the arrangements and instrumentalities shown in the attached drawings.

### DETAILED DESCRIPTION OF THE INVENTION

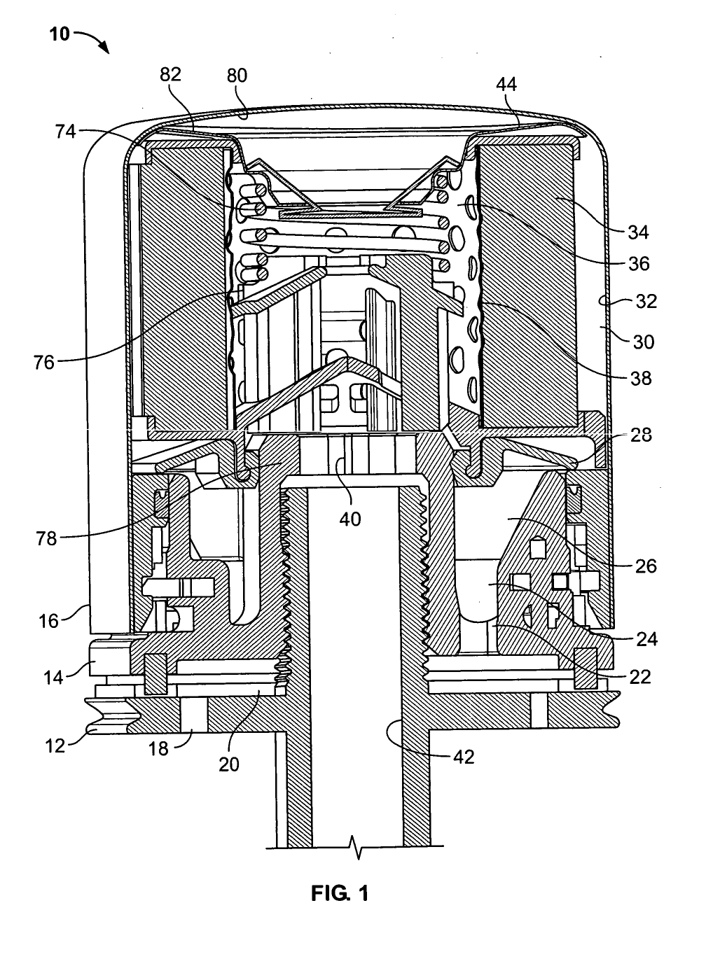

FIG. 1 is an axial section of an embodiment of a fluid filter assembly 10 secured to a mounting stud 12 of an engine. The oil filter assembly 10 includes a first segment, such as base or adapter 14 and a second segment, such as a filter refill, insert or module 16. The filter assembly 10 is configured to filter fluid, such as oil, circulating within an internal combustion engine. The filter assembly 10 is a two piece assembly in which the adapter 14 is secured by a threaded coupling to the mounting stud 12, while the filter module 16 is configured to removably secure to the adapter 14, as discussed in U.S. Ser. No. ______, Attorney Docket Number 17207US01, all of which is incorporated by reference here.

Fluid from a source, such lubrication oil from. an engine block (not shown), passes through one or more inlets 18 of the mounting stud 12 into the generally annular chamber walls 20 of the adapter 14. The fluid then passes through the fluid inlet passages defined by the walls 22 into the generally annular spaces defined by the walls 24 and 26 of the adapter 14. The pressure exerted by the unfiltered oil forces the anti-drain valve flaps 28 open and passes into the generally annular pre-filter chamber 30 defined between the outer shell 32 of the filter module 16 and the filter medium 34. In an embodiment, the passages defined from the inlet 18 through the chamber 30 define the inlet portion of the filter path.

During normal operation of the filter module, in the environment of an oil filter, the unfiltered oil in the chamber 30 passes through the filter medium 34 into the generally cylindrical space 36 defined within the inner wall of the perforated filter medium support 38. The oil flows through the filter medium 34 due to the pressure difference between the chambers 30 and 36 and the permeability of the filter medium 34. The filter medium filters impurities from the oil. The filtered oil then passes through a port 40 and through the fluid outlet passage defined by a bore 42 of the mounting stud 12. The bore 42 delivers the filtered fluid back to the source, such as an engine block in the case of lubrication oil. In an embodiment, the passages defining the generally cylindrical space 36, the port 40, and the bore 42 define the outlet portion of the filter path.

If, however, the filter medium 34 is sufficiently clogged, or if the oil in the engine's sump is sufficiently viscous (due, for example, to cold ambient temperatures at start-up), its resistance to flow will increase to the point where it presents an impediment to the continued supply of lubricant via the outlet portion of the filter path. This issue is addressed by providing a bypass passage that bypasses the filter element 34, allowing fluid to pass more directly from the inlet portion of the filter path to the outlet portion of the filter path. In an embodiment, the bypass passage is defined primarily by the outer shell 32 of the filter module and the pressure relief valve assembly 44.

In an embodiment, the pressure relief valve assembly 44 includes a formed shell or pressure relief cap 46 and a valve seal or element 48. Optionally, as shown in FIG. 1, the pressure relief cap 46 also functions as the media bias spring that loads the media cartridge against the outer shell 32 to prevent rattling of the parts after assembly. The pressure relief cap 46 can have an outer bearing surface 49, a generally annular, in this instance slightly conical, outer perimeter 50, a transition radius 52, a more nearly cylindrical but still somewhat conical portion 54, a transition radius 56, a spring land 58, a transition radius 59, a nearly cylindrical portion 60, a generally conical transition 62, a generally annular portion 64, and a valve aperture defined by an inner rim 66. The generally annular portion 64 can also be conical in another embodiment. The shell 46 generally has upper and lower surfaces 70 and 72.

The inner rim 66 and the generally annular portion 64 define a round valve opening and an annular seat in this embodiment, but the valve opening or seat could be another shape, such as square, or formed by other structure regulating flow through the bypass passage. As a person skilled in the art will appreciate, the specific details of the shell 46 can be varied extensively and many specifics can be omitted or changed. A skilled person will also understand that the shell 46 may be easier or less expensive to form by stamping, molding, die casting, or other methods if all of the most nearly cylindrical portions, such as 60, have a taper or draft allowing a mold surface or tool to be withdrawn axially from each side of the shell 46. The shell 46 can, however, be formed by other processes for which a taper or draft is not needed, as by assembling and joining independent parts or by providing a tool that is withdrawn in a more complex manner, as by having relatively movable parts. Still other contemplated metal forming processes contemplated for making the shell 46 or other parts of the valve assembly 44 are powder injection molding or sintering. Any other method of making the parts of the valve assembly 44 and any suitable metallic or non-metallic material can also be used.

The shell 46 includes several functional features in the illustrated embodiment.

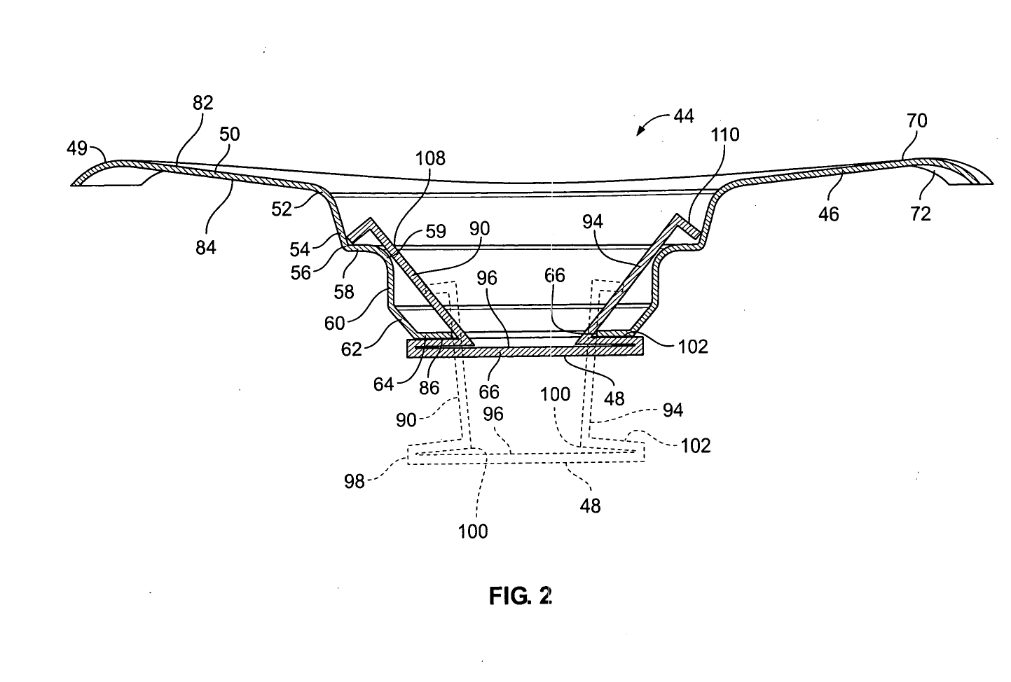

As best shown in FIGS. 1 and 2, the spring land 58 and generally cylindrical portion 60 are sized and positioned to receive the upper end of a coil compression spring 74. The lower end of the spring 74 is received by the drip seal plug 76, so the expanding force of the spring urges the drip seal plug 76 down against the base 78.

Referring to FIGS. 1 and 2 together, the upstream portion of the bypass passage is defined by walls, specifically between the inner surface 80 of the outer shell 32 and the upper or upstream surface 82 of the valve shell 46. The downstream portion of the bypass passage is defined by walls, specifically the lower or downstream surface 84 of the valve shell 46. The downstream portion of the bypass passage merges with the outlet portion of the filter 10 downstream of the valve seal 48.

The force of the spring 74 urges the valve shell 46 upward against the outer shell 32, so the outer bearing surface 49 of the valve shell bears against the outer shell 32. The outer bearing surface 49 of the valve shell and outer shell 32 are not sealed tightly, however, and alternatively may not be sealed at all, particularly if the mating surfaces of the outer bearing surface 49 and the outer shell 32 are not congruent around their entire circumference. In either case, the oil pressure in the pre-filter chamber 30 also will be applied in the upstream portion of the bypass passage between the outer shell 32 and the upper surface of the valve shell 46, particularly if the pressure difference between the upstream and downstream portions of the bypass passage (i.e. between the upper and lower sides of the valve shell 46) is greater than it should be. An excessive pressure difference is indicative that the filter medium 34 is at least partially obstructed and little or no oil is being filtered, and also tends to force the valve shell 46 downward or reduce its bearing force relative to the outer shell 32.

The valve shell 46, on the downstream side of its generally annular portion or seat 64, in an embodiment also defines a sealing lip 86.

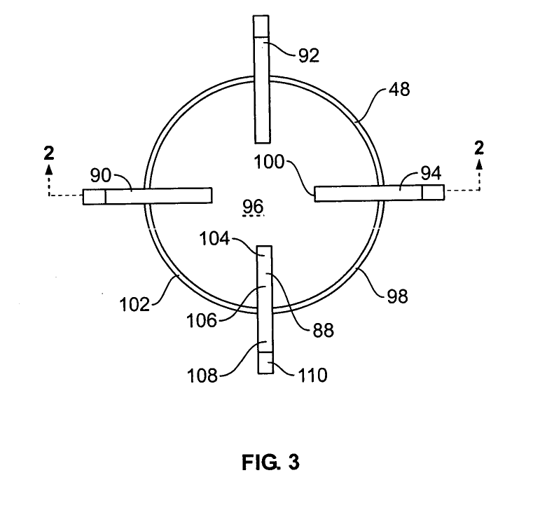

Additionally, the upstream surfaces of the portions 54-66 of the valve shell 46 define bearing surfaces which cooperate with two or more spring legs 88, 90, 92, and 94 of the valve seal 48 (see FIGS. 2 and 3).

The illustrated embodiment of the valve seal 48, in addition to the spring legs 88-94, also has a fluid impervious or resistant upstream surface 96 that is formed inward at its outer perimeter to define a folded outer edge 98 and an inwardly extended edge 100. The generally annular surface between the edges 98 and 100 defines an upstream-facing sealing surface 102. The downstream surface of the valve seal 48 is indicated as 103. The sealing surface 102 and the corresponding portion of the valve seat could also be conical instead of flat.

In an embodiment the spring legs 88-94 are formed of the same piece of material, such as spring steel, as the remainder of the valve seal 48. The spring legs 88-94 extend radially outward and upstream from the inwardly extended edge 100. The spring legs 88-94 are circumferentially spaced about the remainder of the valve seal 48. In an embodiment the four legs are equally spaced at 90-degree increments. Alternatively, fewer spring legs, such as two or three spring legs, could be used, equally spaced at 180-degree or 120-degree increments. As another alternative, five or more spring legs could be provided. Alternatively, the spring legs could be unevenly spaced. Alternatively, the spring legs could be formed as one or more separate parts, such as single legs each having an attachment portion at one end, double opposed legs having an attachment portion connecting the two legs, or a “spider” having more than one leg extending radially from an attachment portion. The attachment portion or portions could be attached to the valve seal to fabricate a one-piece valve seal and spring leg assembly from more than one original part.

More particularly, in an embodiment the spring legs 88-94 have a proximal end portion 104 adjacent to the fold at the inwardly extended edge 100 and a more distal portion that bears on one or more of the upstream surfaces of the bypass passage as defined above. In an embodiment, the more distal portion includes the portion 106 of the spring leg, located very close to the proximal portion 104, that bears on the upstream surface 82 of the seat or near the inner rim 66 of the valve shell 46 when the valve seal 48 is seated. In an embodiment, the more distal portion also includes the portions such as 108 of the spring legs 88-94 that bear against the radius 59 when the valve seal 48 is seated, as well as the portions such as 110 near the distal extremities of the spring legs 88-94 defining out-turned feet that bear against the generally conical portion 54 of the valve shell 46 when the valve seal 48 is seated. In other embodiments, more or fewer of the more distal portions of the spring legs 88-94 can bear against the upstream surfaces of the bypass passage formed, for example, by the upper surface 70 of the valve shell 46. For instance, in different embodiments, one, two, three, or more of the more distal portions of the spring legs 88-94 can bear against the upstream surfaces of the bypass passage. As one illustration, some or all of the spring legs 88-94 could alternatively terminate just distal of the more distal portion 106, and thus would define relatively short spring clips.

The spring legs 88-94 can be made so, in their unstressed positions, they would be spread radially further apart than the upper surface 70 permits when the valve seal 48 is seated, as shown in full lines in FIG. 2. In other words, when the valve seal 48 is seated, the contacting more distal portions of the legs 88-94 bear against the surface 70, which causes the valve seal 48 to bear upward against its seat with sufficient force to resist a normal pressure difference exerted on the valve seal by the fluid pressure in the upstream portion versus the downstream portion of the bypass passage.

The pressure difference exerted on the valve seal 48 by the difference in fluid pressure in the upstream portion versus the downstream portion of the bypass passage will in some instances increase to the extent that the filter element 34 is to be bypassed. When this pressure difference is great enough, the excess pressure acts in opposition to the closing spring force exerted by the spring legs 88-94 and forces the valve seal 48 open by shifting it downstream. The spring legs 88-94 slide along and bear against the seat when the valve opens, levering or bending the spring legs inward toward the center axis of the illustrated valve, increasing the bias of the spring legs against the seat.

Once the pressure difference between the upstream and downstream portions of the bypass passage, and thus the opening force, is reduced, the increase in spring tension as the valve opens tends to force the valve back to its closed position. The legs 88-94 and the valve shell 46 are in this embodiment configured to apply a substantial closing force when opened, as by providing upwardly concave conical surfaces of the valve shell 46 that are contacted by the spring legs 88-94 as the valve seal 48 opens and closes.

To ensure that the valve seal 48 is captured when it opens, it is in an embodiment provided with feet 110 which will catch on the upstream surface 82 of the seat, capturing the valve seal 48 so it does not block the downstream portion of the bypass passage or other downstream structure. In an alternative embodiment, the valve seal could be captured in a suitable location by structure located in the downstream portion of the bypass passage.

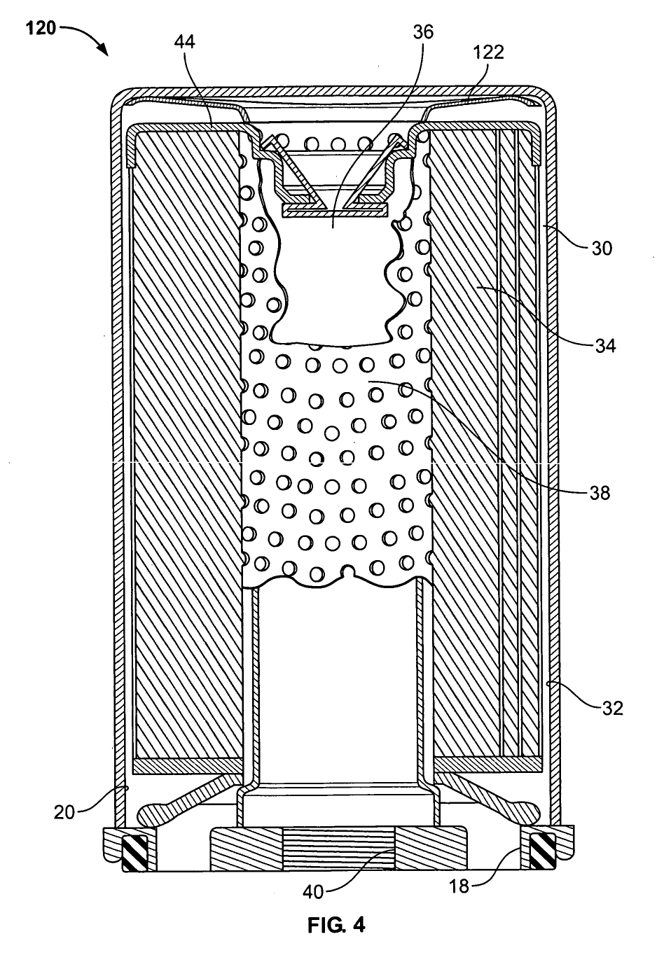

FIG. 4 is an axial section of a fluid filter assembly 120 according to a different embodiment, illustrating that the pressure relief valves described and shown in this specification can also be used in otherwise standard spin-on disposable oil filters. Reference characters of FIG. 4 identical to those of FIGS. 1-3 identify certain corresponding parts of this embodiment. The embodiment shown in FIG. 4 has a media bias spring 122, and the pressure relief vaive assembly 44 is formed in a central portion of the media end cap.

The assembly 120 receives fluid from the inlets 18 into the generally annular chamber defined by the walls 20. This generally annular chamber communicates with the generally annular pre-filter chamber 30 defined between the outer shell 32 of the filter assembly 120 and the filter medium 34. In an embodiment, the passages defined from within the inlet 18 through the chamber 30 define the inlet portion of the filter path.

Downstream of the filter medium 34 a generally cylindrical space 36 can be defined within the inner wall of the perforated filter medium support 38. The space 36 communicates via a port 40 back to the fluid source, such as an engine block in the case of a lubrication oil filter. In an embodiment, the passages defining the generally cylindrical space 36 and the port 40 define the outlet portion of the filter path.

The bypass passage that bypasses the filter element 34, allowing fluid to pass more directly from the inlet portion of the filter path to the outlet portion of the filter path, is defined primarily by the outer shell 32 of the filter module and the pressure relief valve assembly 44. In an embodiment, the valve assembly 44 shown in FIG. 4 can be constructed and operate as described in connection with FIGS. 1-3.

In the embodiments shown in FIGS. 1-4, the pressure relief valve assembly 44 is contemplated to be a low-cost alternative to the conventional bypass valve assembly requiring a separate valve plug and coil spring.

In an embodiment (not illustrated), a signal can be provided to reveal the fact that the pressure relief valve 44 has opened and the fluid filter assembly 10 is no longer filtering the fluid passing through it. One example of such a signal would be an electronic component within the filter that detects a pressure drop in the bypass passage or opening of the valve 44 and sends a signal to a light on the dashboard of the vehicle in which the oil filter is mounted. Another example of such a signal would be a window in the outer shell 32 allowing observation of the displacement of a portion of the valve seal 48 or an attached signal or flag into, out of, or across the window. Many other sensors and signaling arrangements can readily be devised by a person skilled in the art.

Thus, embodiments of the present invention provide a fluid filter assembly, such as an oil filter assembly, that has a bypass valve.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiments disclosed, but that the invention will include all embodiments falling within the scope of the appended claims.

1. An oil filter comprising:
a. a filter path having an inlet and an outlet;
b. a filter element interposed in said filter path between said inlet and said outlet;
c. a bypass passage defined by walls and extending between said inlet and said outlet; and
d. a pressure relief valve in said bypass passage that opens when the pressure in said inlet exceeds the pressure in said outlet by an amount sufficient to open said valve, said pressure relief valve comprising:
i. a seat having an upstream side and a downstream side, said upstream side defined by upstream walls of said bypass passage and said downstream side defined by downstream walls of said bypass passage, said downstream walls defining a lip surrounding said bypass passage;
ii. a valve seal having an upstream-facing sealing surface, the valve seal being positioned in said bypass passage and movable from a closed position against said lip downstream to an open position allowing fluid to flow through said bypass passage; and
iii. a plurality of generally circumferentially spaced spring legs having proximal portions secured to said sealing plate and more distal portions bearing against an upstream wall of said bypass passage for biasing said sealing plate against said lip.

2. The filter of claim 1, wherein said valve seal and plurality of spring legs are formed as a single piece.

3. The filter of claim 2, wherein said single piece is metal.

4. The filter of claim 3, wherein said metal is formed from a sheet.

5. The filter of claim 3, wherein said metal is formed by die-casting.

6. The filter of claim 1, wherein said plurality of spring legs comprises at least three spring legs.

7. The filter of claim 1, wherein said plurality of spring legs comprises at least four spring legs.

8. The filter of claim 1, wherein said seat comprises a generally annular cap.

9. The filter of claim 8, wherein said seat is generally concave on its upstream side.

10. The filter of claim 1, wherein said seat is formed of sheet metal.

11. The filter of claim 1, wherein the upstream side of said seat defines an upstream wall of said bypass passage.

12. The filter of claim 1, wherein the downstream side of said seat defines a downstream wall of said bypass passage.

13. The filter of claim 1, wherein said valve seal is a plate having a generally annular sealing surface.

14. The filter of claim 13, wherein said plate is formed of sheet metal.

15. The filter of claim 1, wherein at least one said spring leg has a distal end located distal of said more distal portion.

16. The filter of claim 15, further comprising feet near or at the distal ends of at least two said spring legs, said feet extending laterally from said spring legs and engaging an upstream wall of said bypass passage.

17. The filter of claim 16, wherein said feet are adapted to capture said valve seal adjacent to said seat when said valve is opened.

18. The filter of claim 1, wherein said pressure relief valve is adapted to reversibly open when the pressure difference between said inlet and said outlet becomes great enough to open the valve.

19. The filter of claim 1, wherein the more distal portions of at least two of said spring legs are adapted to slide along and bear against the seat when the valve opens, levering the spring legs inward as the valve opens.

20. The filter of claim 1, wherein the more distal portions of at least two of said spring legs are adapted to bear against the seat when the valve opens, exerting a closing bias on the valve seal.
